(19) United States
(12) Patent Application Publication
(10) Pub. No.: US 2002/0056003 A1
(43) Pub. Date: May 9, 2002

(54) System and method for real-time multi-directional file-based data streaming editor

(76) Inventor: Dinkar Goswami, Potomac, MD (US)

Correspondence Address: Gausa L.L.C., Suite 500, 600 14th Street, N.W., Washington, DC, 20005, US

(21) Appl. No.: 09/829,908

(22) Filed: Apr. 11, 2001

Related U.S. Application Data
(60) Provisional application No. 60/196,088, filed on Apr. 11, 2000.
(60) Provisional application No. 60/223,185, filed on Aug. 4, 2000.
(60) Provisional application No. 60/251,004, filed on Dec. 4, 2000.

(51) Int. Cl. G06F 15/16

(52) U.S. Cl. 709/227

(57) ABSTRACT

This invention provides a system and method for multiple users to simultaneously access selected files during an online session. Each of the users has read access to each of the other users' selected files. Each user can edit each of the other users' files, although only a single user may edit any file at a given point in time. The invention synchronizes editing control among the users. Each time a user edits a file, the edit is automatically cascaded to all session participants.

### BENEFIT OF EARLIER FILED APPLICATION

This application claims the benefit of U.S. Provisional Application No. 60/196,088, filed Apr. 11, 2000, U.S. Provisional Application No. 60/223,185, filed Aug. 4, 2000, and U.S. Provisional Application No. 60/251,004, filed Dec. 4, 2000, all of which are incorporated by reference herein.

### FIELD OF THE INVENTION

This invention relates generally to data processing systems and, more specifically, to systems and methods that provide real-time multi-directional file-based data streaming editors.

### BACKGROUND OF THE INVENTION

The Internet is increasingly used as a collaboration tool among groups of users who are physically not located in the same area. Collaboration generally includes multiuser access to a file. It is often desirable if the collaborating parties have joint editing and viewing capabilities. For example, remote Internet users may desire to participate in virtual meetings, distance learning, virtual seminars, and online conferencing. The current marketplace offers various systems that allow users to collaborate over a network. However, many of the conventional systems do not provide the safeguards that are useful to protect confidential information on a desktop, while providing complete multi-user access to one or more files.

At a basic level, email and chat systems allow users to exchange information, ideas and files over a network. Both of these systems have obvious shortcomings. An email message is sent from one user to another as a series of packets routed through a network. The packets are not necessarily sent according to the same path and therefore may not arrive at the destination node in order. The packets are re-ordered at the destination node and delivered to the intended recipient once all of the packets have been received. This process may take anywhere from a couple of seconds to several hours. Email is therefore limited by its transmission time and fails to support real-time collaboration. Chat and instant messaging systems provide a more real-time manner for users to exchange text messages. Collaboration may prove more valuable, however, when users are able to exchange and compare files in real-time.

Some systems which allow remote users to exchange and compare files in real-time do exist. These systems can generally be grouped as either desktop sharing or capturing applications, or whiteboard applications. Whiteboard applications provide a common work area where multiple remote users can input data, which is reflected to all other users participating in a session. The users' input is generally in the form of annotations. Desktop sharing and capturing applications allow multiple users to access the contents of an initiating computer, or of an application. Conventional desktop sharing and whiteboard application systems are subject to several shortcomings, some of which are outlined below.

First, these conventional systems generally either (1) provide users with access to all of the files included on the hard drive, in a specific directory of the initiating computer, or relative to a specific application on the initiating computer; (2) or only provide access to a single file. Additionally, many of the conventional systems fail to provide all of the users with editing, printing, saving, etc. capabilities. Even when all users are provided with complete editing capabilities, the user of the initiating machine generally has superior editing rights that preempt those of other users. This can potentially decrease the value of the collaboration process. Additionally, such systems only allow a single copy of the file (i.e., the copy of the file that is on the initiating machine) to be modified, regardless of which user is initiating the edit operations. Thus, even if a remote user edits the file, only the copy of the file that is located on the initiating computer can be saved. The users must transmit the modified file among themselves via, for example, email, and each user will have to save the modified file outside of the desktop sharing or capturing application. Further, such systems usually limit the file sharing capabilities to a single file. Tools that do support simultaneous access to multiple files may require each user to manually position the file on the screen so that they may be viewed. Still further, users can only view a file that has been opened in application that is supported by their local machines. Finally, conventional systems do not include a control transfer feature that allows one remote user to assign access rights to another remote user. Rather, such systems allow all remote users to access all files of a initiating computer.

Accordingly, a need exists for a tool that will allow multiple remote users to collaborate over a file, while overcoming the shortcomings of conventional systems.

### SUMMARY OF THE INVENTION

This invention, in a preferred embodiment, provides an online, multi-directional file-based data streaming editor that allows multiple users to simultaneously compare, merge, and instantly edit files, while concurrently communicating with one another over a dedicated connection.

In accordance with an embodiment of the invention, an online file editing method is provided. The method includes creating a session that allows at least two users with simultaneous to access a file, where each user has access to a replica of the file, receiving from a user an edit instruction indicating a file edit, editing a replica of the file according to the edit instruction, and automatically cascading the file edit to each replica of the file.

In accordance with another embodiment of the invention, an online file editing method is provided. The method includes providing at least two users with simultaneous access to a file such that each user has access to a replica of the file, providing one of the at least two users with a capability to edit a local replica of the file, and automatically cascading the edit to all of the replicas of the file.

In accordance with yet another embodiment of the invention an online file editing method is provided. The method includes uploading the file from a first client to a server, providing to the first client and a second client simultaneous access to a replica of the file, a first replica and a second replica, respectively, receiving from one of the first client and the second client an edit command to edit one of the first replica and the second replica, editing the one of the first replica and the second replica of the file according to the edit command, and automatically editing or causing to be edited an other of the first replica and the second replica of the file according to the editing of the one of the first replica and the second replica of the file such that the editing is performed at a same location of the other of the first replica and the second replica of the file as it was performed in the one of the first replica and the second replica of the file.

In accordance with an embodiment of the invention a system to edit a file over a network is provided. The system includes a first client, which includes a first file and an editor that allows a user of the first client to access a replica of a second file, a second client that includes the second file and an editor that allows the second client to access a replica of the first file, and a server that provides the first client and the second client with simultaneous access to the replicas of the first and second files.

### BRIEF DESCRIPTION OF THE DRAWINGS

FIG. 1 depicts an exemplary computer network suitable for practicing the invention.

FIG. 2 depicts an exemplary flow diagram of the processing performed relative to this invention.

FIG. 2A depicts an exemplary screen shot of a form that can be used to create a session.

FIG. 2B depicts an exemplary screen shot of a page that can be used to upload a file from a participant's local drive to a server. FIG. 3 depicts an exemplary screen layout of a virtual meeting space tool interface in a two user implementation in accordance with the present invention.

FIG. 3A depicts an exemplary screen shot of the screen layout depicted in FIG. 3.

FIG. 3B depicts an exemplary screen shot of the screen displays of both participants of a two-participant session in accordance with the present invention.

FIG. 4 depicts an exemplary screen shot of a multi-user interface.

### DETAILED DESCRIPTION OF THE INVENTION

This invention provides an interactive web-based communications tool which serves as an online, multi-directional file based streaming editor. This “virtual meeting space tool” allows multiple remote users to collaborate in real-time such that the users can compare, merge and instantly edit a file, while simultaneously communicating with each other online. The merging or edit performed is immediately and simultaneously “cascaded” to all session users. The term “cascade,” as used herein, refers to automatically sending, or causing to be sent, an edit made in one file to all other files of a session, ensuring that the edits are made in the same place in each of the files. The process of cascading thus may include receiving an edit command, creating one or more packets reflecting the changes made to the file, compressing and encrypting the packets, sending the packets to all replicas of the file that are included in a session, ordering the packets at a destination, and editing the file according to the edit command, while ensuring that the edit is applied to an appropriate part of a file (i.e., the edit is made at a point of the file that corresponds to a point of the file where the edit was initially made). It is important to note that each session participant accesses a replica of a file, as distinguished from a copy of the file, which implies that an original exists and the others are copies of the original. According to this embodiment of the invention, each replica of the file is continuously updated and maintained consistent with each of the other replicas of the file, as modifications to a replica of a file are automatically cascaded to all other replicas of the file.

An “initiating” user initiates and session, which can be joined by one or more “invitees.” Collectively, the initiating user and invitee(s) are referred to as “participants.” Any of the session participants can be in control of a session and therefore function as a host of the session. Each session creates a dedicated link among session participants. The initiating user can create and delete a session. Invitees may join scheduled or ongoing sessions. Each session is uniquely identifiable according to information that is maintained by the system, for example, in a database. Further details on creating and joining sessions are provided below.

In particular, the invention allows multiple users to simultaneously access a file, while one of the multiple users can edit the file at a time. The system explicitly indicates which of the users has editing control at a given time, and allows the user with editing control to transfer such editing control to another user as desired, i.e., the host user can change throughout a session. As a file is edited, changes are automatically and immediately cascaded to other session participants. Therefore, changes to a file can be viewed in real-time by other session participants. The virtual meeting space tool also provides additional editing features, such as, for example, tracking of changes, spell check, save, print, etc.

More specifically, the virtual meeting space tool provides a single interface that allows multiple network users to transfer files among one another, simultaneously open the files on each of the users' respective computers, edit the files, discuss the files via a one to one discussion interface, and browse the Internet while performing the above functions. The virtual meeting space tool interface includes an editor, a “switch” utility which allows a single user to retain control of a file at a given time, a chat area, a reference area, and an instant messaging utility, each of which is described further below. A user can therefore open a file and, in a parallel frame, open a file that has been received over the network. The interface provides an editor which allows users to perform a variety of editing functions on a file.

The virtual meeting space tool in accordance with the invention provides various operational advantages that are not provided by conventional systems. For example, the virtual meeting space tool allows users to compare, merge and edit his or her own files, as well as the files of other session participants. Edits made to a file are transmitted simultaneously to all session participants, without a user initiating a “send” or “transmit” action. All session participants can save or print a file during the session. Further, during a session all participants may open, create or edit a file that cannot be viewed or otherwise accessed by other session participants. Such files can be merged with a shared file, regardless of the original owner of the shared file. The merged file is automatically transmitted to other session participants, as would a file that has been edited via the virtual meeting space interface. A “discussion area” section of the interface provides a chat function that allows participants of a session to discuss over files in real-time. The system further includes a manner for the users to designate one of the participants as having control over a file at a given time. The participant who has control can merge, edit, save, or print a file, and transfer control of the file in its full form to another session participant. Additionally, the invention allows an owner of a file to assign access permissions to replicas of the file. For example, a file owner can provide other session participants with permission to edit the file, but deny such participants permission to print or save the file, or vice versa. Further, in an embodiment, the invention can automatically compare two files and indicate the differences on the display.

The files may be in a variety of file or media formats, including, for example, text, hypertext markup language (html), graphics, AVI, etc. In some embodiments, the tool may also enables users to browse the Internet while accessing shared files. In an embodiment of the invention, a user can open a file in one part of a screen and open in another part of the screen a file that was forwarded to the user during the current session, and work on both simultaneously. Similarly, in an embodiment of the invention, session participants can copy text and objects from each other's files and paste them in their own respective files, thereby editing their own files based on the simultaneous discussions and suggestions taking place through the discussion area without affecting the shared files. After editing, both users can save, print, or download the file and the discussion that occurred in the discussion area.

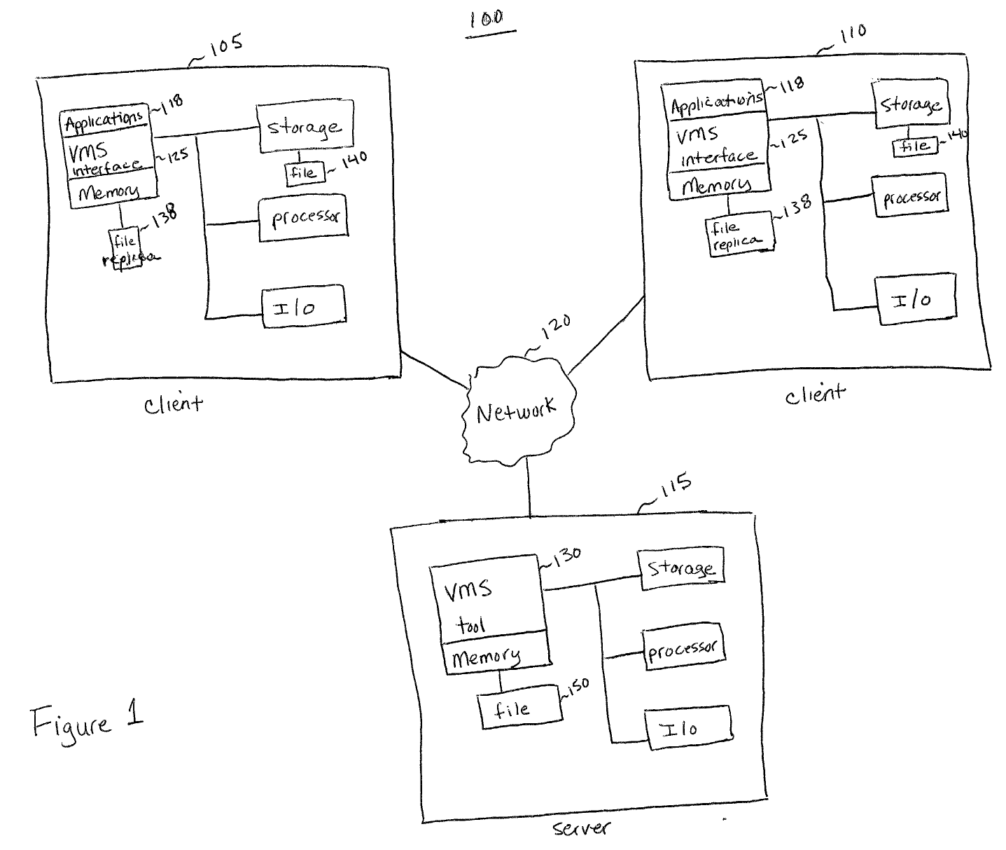

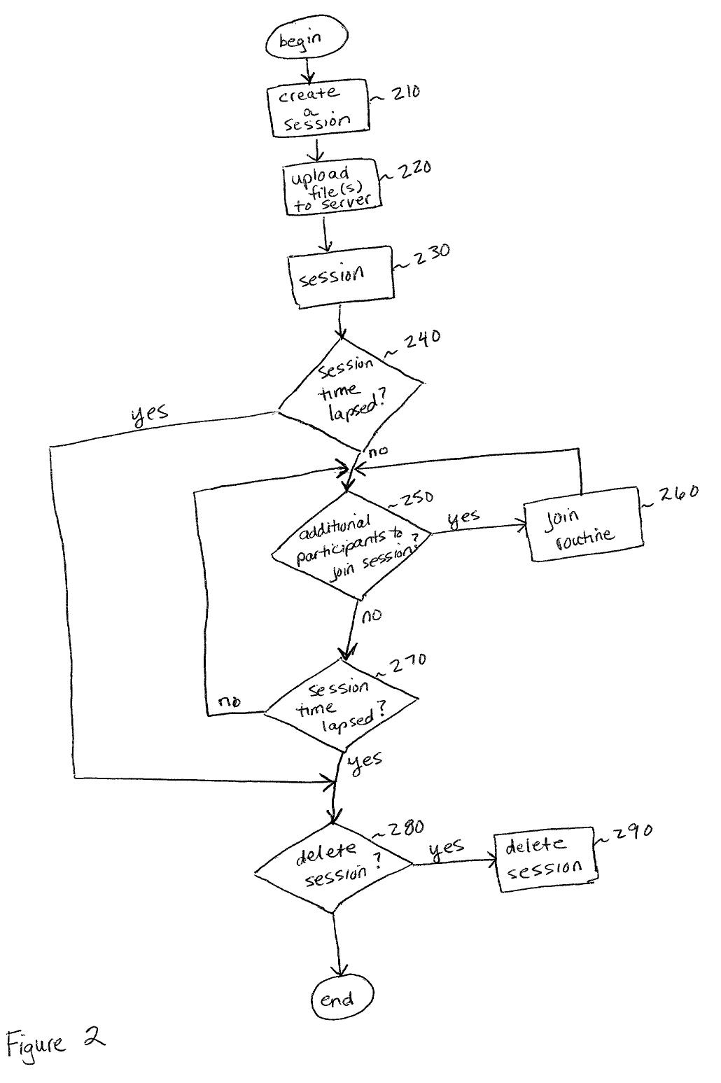

FIG. 1 depicts an exemplary computer network 100 suitable for practicing the invention. Network 100 includes clients 105 and 110, which communicate with one another and server 115 via network 120. Clients 105 and 110 preferably correspond to desktop computers. Network 120 corresponds to any public or private network, such as, for example, the Internet or a LAN. Each of clients 105 and 110 include the conventional components of a computer including memory, at least one processor, storage, and input and output devices. One of skill in the art will appreciate that while clients 105 and 110 have been depicted in FIG. 1 with a storage device, the invention may be practiced with dummy terminals that do not include storage devices. Specifically, in such embodiments, no stored file is necessary. A document can be prepared, online or offline, or a user can join a session without contributing a file. The memory further includes one or more applications 118 that are used to create and open files that are transmitted and displayed according to the interface of the invention and a virtual meeting space tool interface 125 that allows files to be opened, edited, and shared with session participants. The applications may include, for example, text, graphics, or spreadsheet applications. Session participants can upload locally stored files to server 115, which are downloaded to each session participant's computer when the file originator opens the file via the interface 125. An edit function of the virtual meeting space tool interface 125 provides a single user with permission to edit a file. All other session participants are only provided read access to the open session files. Each session participant has access to a local replica 138 of other session participants' files. The interface 125 will transfer edit control to another participant upon receiving an appropriate input. The virtual meeting space interface 125 is user friendly and includes, for example, a series of pull down menus, forms and selectable items.

The editor supports a variety of edit functions including, for example, typing, formatting (e.g., bold, italic) and clipboard operations (e.g., cut, replica, paste), and operations that respond to keyboard and mouse events, operations performed via a toolbar, and operations performed via a mouse click. The editor determines where an edit occurred and also determines the properties of the edit, e.g., color, font, format, etc. It also supports opening and saving of files that include both formatted and non-formatted text. The editor may further include a speech recognition feature. The editor opens text files in a rich text file format (RTF) such that the location of each character of a file is uniquely identifiable. Thus, whenever an edit command is received, the system performs the edit on the replica of the file on which the edit is made and then makes the same change in the same location on all corresponding replicas. Similarly, in a spreadsheet implementation, each cell of a file is marked according to a unique identifier corresponding to a cell address and for a graphic file, lines of marking uniquely identify screen coordinates of the file. The cascading process receives an edit from a marked place of a file and sends the edit to the same marked place of a replica of the file.

Because the editor works according to type and location of an edit, it is language independent. Therefore, the editor can handle fonts of any language that a user has installed on his or her computer. The editor also allows each of the session participants to edit local files, i.e., files other than the shared replicas, during a session. For example, if one participant has edit control, while that participant is editing a replica of a file, the other participant may be working locally on a file that is stored on the hard drive.

Server 115 also includes the conventional components of a computer including memory, at least one processor, storage and input and output devices. The memory of server 115 further includes virtual meeting space tool 130 which allows multiple users to access files simultaneously. The tool 130 coordinates interaction among users via the interface 125. Files that may be simultaneously accessed by the multiple users are uploaded from a user's local storage 140 on a client 105 or 110 to server 115 for virtual storage as file 150. The virtual meeting space utility 130 is not language or application dependent. It is operable with any application included on clients 105 and 110.

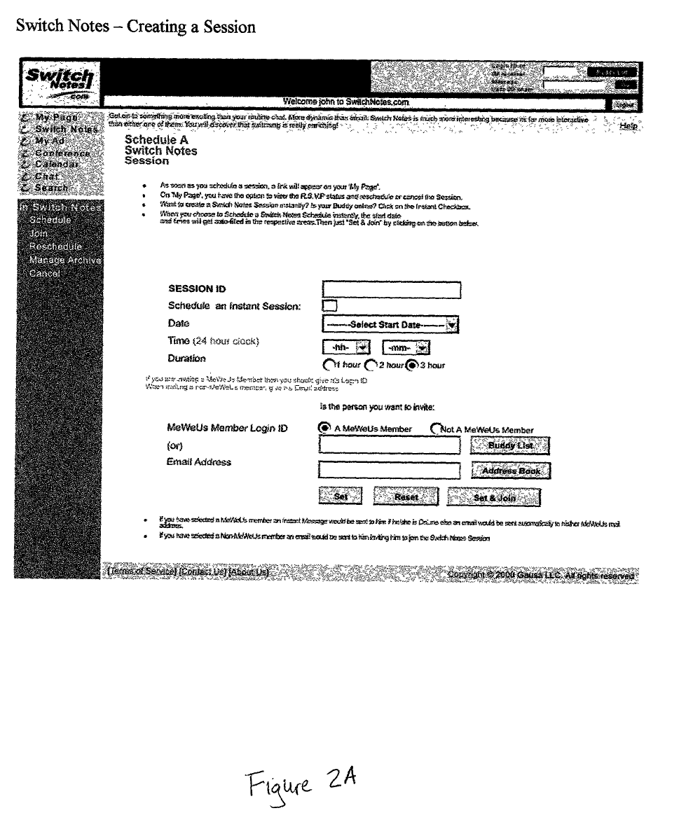

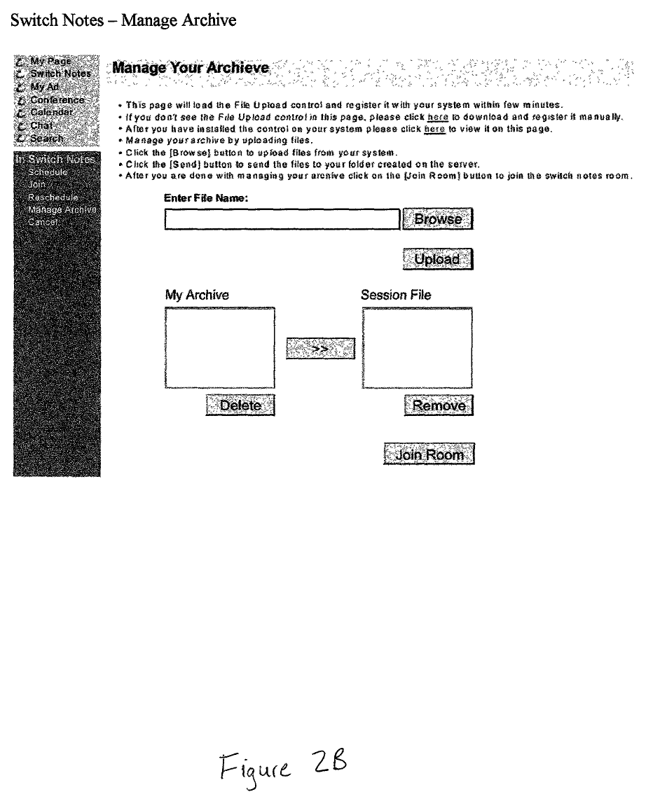

FIG. 2 depicts an exemplary flow diagram of the operation of a virtual meeting space tool in accordance with the present invention. A initiating user begins by creating, i.e., scheduling, a session (210), i.e., the user who creates a session is also the initiating user of the session. FIG. 2A depicts an exemplary screen shot of a from that can be used to create a session. A session is identified according to a unique identifier and has a begin time and an end time. A session may therefore be represented, for example, by an application level array that includes a title, a description, one or more invitees, an initiating user, and a session application number. When creating a session, a system user provides the necessary information via the system interface. The creator of a session indicates each of the desired session participants because only indicated participants will later be allowed to join the session. The creator of a session can amend the list of invitees to reflect additional participants at any time between creation and deletion of the session. After a session is created, the system notifies each of the invitees of the session, for example, by sending an instant message to each of the invitees, informing them of information about the session, including its name, initiating user and time of operation.

In this embodiment, to begin a session a session participant uploads one or more files to a server (220). FIG. 2B depicts an exemplary screen shot of a page that can be used to upload a file from a participant's local drive to a server. The virtual meeting space tool interface on each user's computer performs this upload function. The files that are uploaded to the interface can be accessed by any of the participants of a particular session. Once a file has been uploaded, it is treated as a virtual file in that a replica of the file resides on the server until it is opened by its originator. When a file is opened, a replica of the file is downloaded to a memory area of each of the session participants' machines. It should be noted that the session participants may upload additional files to the server as desired throughout the session. Additionally, session participants may create new files or download files retrieved from an Internet browsing session and upload the files to the server. All such files may be viewed by other session participants when the originator opens the files.

Once an uploaded file (which resides at the server in this embodiment) has been opened, a replica of the file is downloaded to the local interface of each of the session participants. As described above, each of the session participants has full access to shared files, including editing, saving, merging and printing capabilities (230). As described above, during a session, changes made by each participant are automatically cascaded to other session participants. A single session participant has editing control of all session files at a given time during the session. The session participant in control can save, edit, merge, or print a file. When a session time lapses (240 and 270), the session may be closed or extended. Prior to closing a session, the system provides each participant an opportunity to save the replica of the file.

Additional participants may join a session at any time (250 and 260). A user may joins a session by providing an appropriate input to the system, for example, by selecting an icon on the system interface. Only users who are listed as invitees to a session may join a session. Therefore, if a user attempts to join a session and the user is not indicated as an invitee to the session, the system denies the user access to the session. Each time a new user joins a session, the system automatically reformats the display of all participants to reflect the newly joined participant. A user may join a session at any time during the duration of the session.

After the session time has lapsed, as indicated above, the session automatically terminates (270). While a session can be deleted by its creator at any time after the session has been created, this exemplary flow diagram illustrates a session deletion as occurring after the session has been terminated (280). To delete a session (290), the session initiating user selects an indicated session from a list of sessions and deletes it. When a session is deleted, all files associated with the session that are stored on the server are also deleted. Receiving and processing the information relative to creating, joining and deleting sessions is well-known in the art and therefore not described in further detail herein.

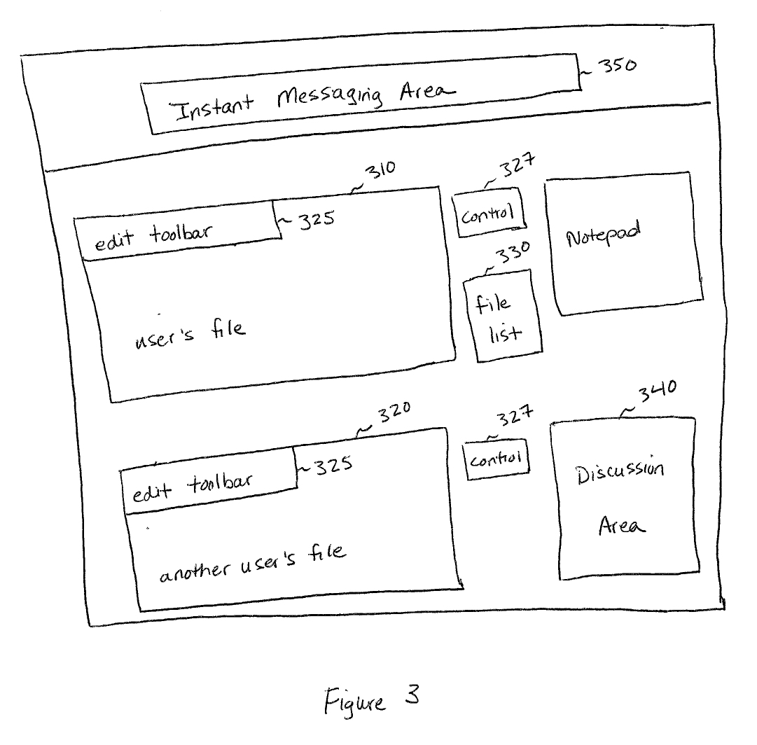

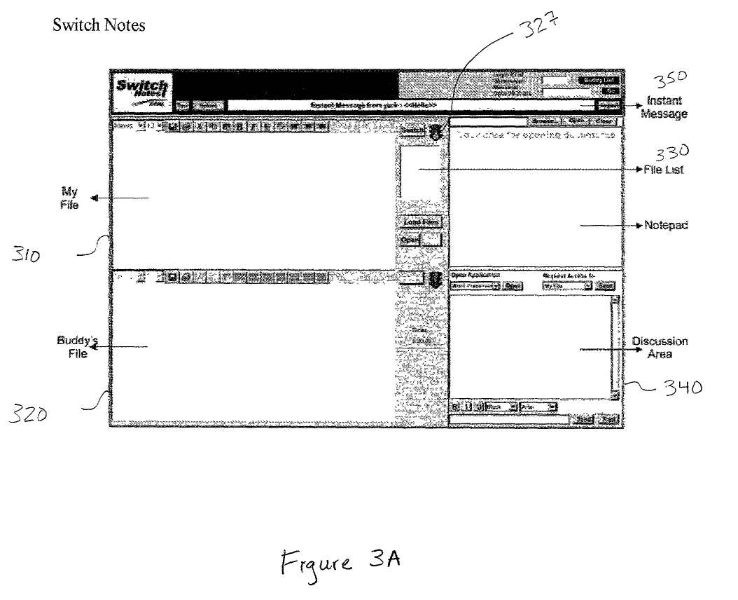

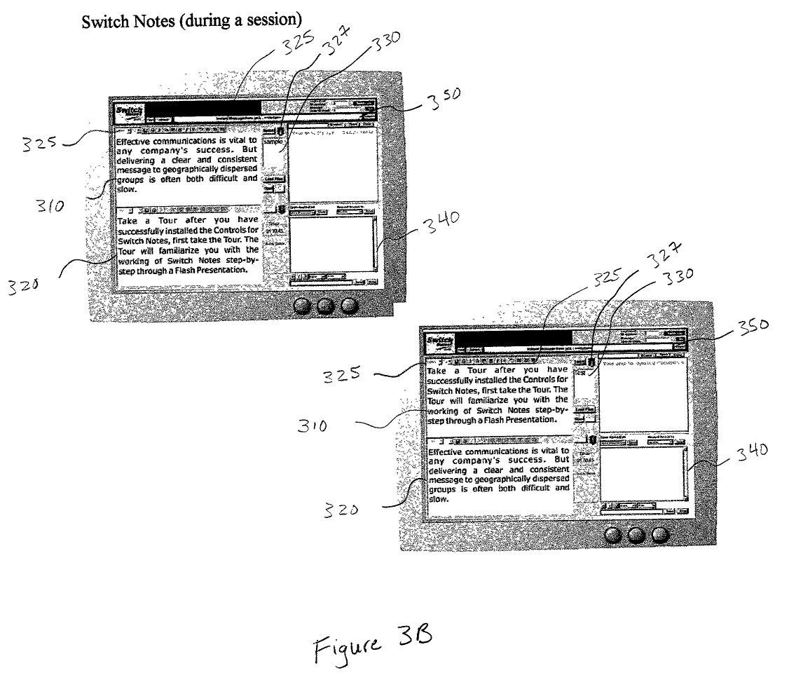

FIG. 3 depicts an exemplary screen layout of a virtual meeting space tool interface in a two user implementation in accordance with the present invention. FIG. 3A depicts an exemplary screen shot of the screen layout depicted in FIG. 3. As depicted, the interface simultaneously displays both the current user's file and another user's files, 310 and 320, respectively. Each of the session participants can edit any of the open files in the session according to the editing functions provided on edit tool bar 325. Each session participant can open a single file at a time, although each session participant can open multiple files during a session. Files can be edited by the participant that has edit control at a particular point in time. Control indicators 327(a) and (b) correspond, for example, to selectable buttons that both indicate which participant has control and provides that control to the indicated participant. The participant having control is the only session participant who possesses complete file editing capabilities. Thus, control indicators 327(a) and (b) indicate whether a particular participant can perform edits or not. For example, the control indicators 327(a) and (b) may be of different colors such that a green indicator 327(a) indicates that the user 310 can perform editing operations on all session files and a red indicator 327(b) indicates that the user 320 only has read access rights to all of the open session files. The edit functions of all participants not having control are effectively locked such that the participants have read only access to the open files. Read only file access includes scrolling operations.

Edit tool bar 325 includes basic editing operations including, for example, clipboard operations such as cut, paste and copy, drawing functions, formatting, etc. The editor also includes a function that records editing operations performed by the user. This function therefore supports undo, redo, and track change editing operations. Each time an edit is performed, the edit data is cascaded over the network and transmitted to each of the files included on a computer that is participating in the session. To appropriately cascade data edits, the system determines the following information: (1) the edit; (2) the type of the edit, e.g., type formatting, a clipboard operation, etc; and (3) where in the file the edit occurred. The virtual meeting space utility compresses and encrypts the cascaded data to ensure that it is sent according to an optimal transmission rate. Conventional compression and encryption techniques are used to compress and encrypt the data.

When transmitting data across the network among computers, the system ensures that the data is consistent and that lost data is tracked and restored. The system uses a sequential data checking mechanism in which each data packet sent from one node to another is sequentially numbered. Any discrepancy in the order of received packets indicates a data loss. When a data loss is detected, a data restoration mechanism is used to retrieve the lost data from the originating machine. In this embodiment, when a data loss is detected, the control indicators 327(a) and (b) are turned to yellow to indicate such data loss. During this time, none of the session participants can edit a file. When the data loss has been corrected, i.e., when the data restoration is complete, the control indicators 327(a) and (b) are returned to their previous color and edit control is returned to the previously indicated participant. One of skill in the art will appreciate that there are different means of indicating data loss, such as, for example, a speech prompt.

Screen area 330 provides an area where a user can list all of the files that have been uploaded to the server. Each session participant can upload multiple files to the server. Once a file is opened, it is downloaded from the server to the local machine of each of the session participants. Edits to the file are thus made on a local replica of the file. As edits are made to a replica of the file, the edits are automatically cascaded to all other replicas of the file. Each time a new file is opened, the current file is closed. Prior to closing a current file, the system allows the participant in control to save the file. The participant in control can provide such control to other participants so that they may save the file as well. Screen area 340 corresponds to a discussion area, where participants can engage in a real-time chat session, transmitting text among each other. For example, the screen layout could conform to a side-by-side arrangement of 310 and 320, and 330 and 340, respectively.

FIG. 3B depicts an exemplary screen shot of the screen displays of both participants of a two-participant session. In the example, the display screens of the two participants are swapped such that screen areas 310 and 320 are reversed on the screens of the users, i.e., the top portion of each user's display screen includes the user's file. Whichever participant has edit control, however, can edit both files included in screen areas 310 and 320 via edit toolbar 325. Each participant has a different list 330 of files that were uploaded to the server. And each user's display includes control indicators 327, a discussion area 340, and an instant messaging area 350.

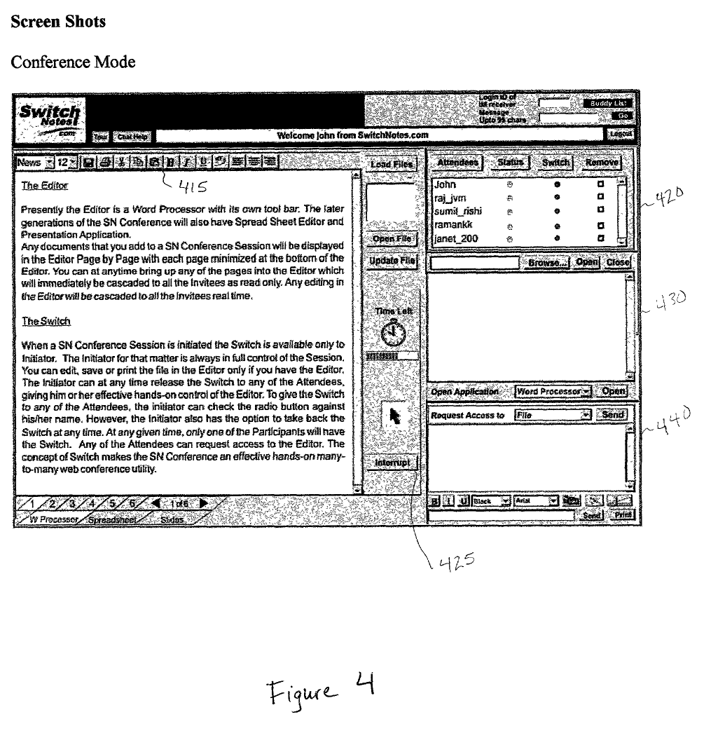

FIG. 4 depicts an exemplary screen shot of a multi-user interface. A multi-user interface may be: (1) the same format of the two user interface described above, where user may open a file, which can be accessed by all other participants. In this implementation, the interface would include the same screen components, although each of the screen areas would be of a smaller size; or (2) a single file that has been made accessible to multiple session participants. In this implementation, as described above, a single participant has edit control at a given point in time and such control can be easily transferred to another participant. Additionally, each participant has a replica of the file, to which any edits made to another replica of the file are automatically cascaded.

In the exemplary interface depicted in FIG. 4, a single file is displayed. The screen of each participant in the session depicted in FIG. 4 would closely resemble the exemplary display that is shown. The file is displayed on the left hand side of the interface. An edit toolbar 415 is included at the top of the file display area. Multiple invitees, listed at 420, can access the file. For each invitee, the system indicates the following: status, switch, and selection. The status area indicates whether the invitee is participating in the session. The switch area indicates which user has edit control at a given time. The participant having edit control can transfer such control to another session participant by selecting, for example, interrupt 425. The remove area allows a session participant to indicate to other participants that he or she is leaving the session. 430 and 440 correspond to additional areas where a session participant can browse, open and send additional files, and chat with other session participants. One of skill in the art will appreciate that these screen shots are for illustrative purposes, and that an actual screen may include additional or different features.

Although this invention has been described relative to a particular embodiment, one of skill in the art will appreciate that this description is merely exemplary and the system and method of this invention may include additional or different components. This description is therefore limited only by the appended claims and the full scope of their equivalents.

Further details of the virtual meeting space tool are provided below. The following description further explains implementation details of novel aspects of the invention. In the following description, the term “buddy” refers to an invitee, “Switch Notes” refers to the invention, and “switch” refers to transferring control among session participants.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An online file editing method, comprising:
creating a session that allows at least two users with simultaneous to access a file, where each user has access to a replica of the file;
receiving from a user an edit instruction indicating a file edit;
editing a replica of the file according to the edit instruction; and
automatically cascading the file edit to each replica of the file.

2. An online file editing method, comprising:
providing at least two users with simultaneous access to a file such that each user has access to a replica of the file;
providing one of the at least two users with a capability to edit a local replica of the file; and
automatically cascading the edit to all of the replicas of the file.

3. The method of claim 2, comprising transferring the capability to edit a local replica of the file to an other of the at least two users.

4. An online file editing method, comprising:
uploading the file from a first client to a server;
providing to the first client and a second client simultaneous access to a replica of the file, a first replica and a second replica, respectively;
receiving from one of the first client and the second client an edit command to edit one of the first replica and the second replica;
editing the one of the first replica and the second replica of the file according to the edit command; and
automatically editing an other of the first replica and the second replica of the file according to the editing of the one of the first replica and the second replica of the file such that the editing is performed at a same location of the other of the first replica and the second replica of the file as it was performed in the one of the first replica and the second replica of the file.

5. The method of claim 4, comprising providing to one of the first and second client authority to edit the file.

6. The method of claim 4, comprising providing to one of the first and second clients authority to save the file.

7. A system to edit a file over a network, comprising:
a first client, which includes a first file and an editor that allows a user of the first client to access a replica of a second file;
a second client that includes the second file and an editor that allows the second client to access a replica of the first file; and
a server that provides the first client and the second client with simultaneous access to the replicas of the first and second files.

8. The system of claim 7, wherein the editor allows one of the initiating client and the remote client to edit the file at a given time.

9. The system of claim 7, wherein the editor allows both the initiating client and the remote client to edit the file.

10. The system of claim 7, wherein the editor automatically cascades an edit made to the first replica of the file to the second replica of the file.
